(19) United States
(12) Patent Application Publication
(10) Pub. No.: US 2002/0038273 A1
(43) Pub. Date: Mar. 28, 2002

(54) Method and system for investment integration

(76) Inventors: C. John Wherry, Mercer Island, WA (US); Frederick L. A. Grauer, Atherton, CA (US)

Correspondence Address: WILSON SONSINI GOODRICH & ROSATI, 650 PAGE MILL ROAD, PALO ALTO, CA, 943041050

(21) Appl. No.: 09/903,051

(22) Filed: Jul. 10, 2001

Related U.S. Application Data
(60) Provisional application No. 60/218,105, filed on Jul. 13, 2000.

(51) Int. Cl. G06F 17/60

(52) U.S. Cl. 705/36

(57) ABSTRACT

A method and system for investment integration. Investment managers, when managing an investment portfolio, are aided by a number of investment tools. Each tool performs a number of functions. As a manager selects the tools best suited for his or her sector of the investment industry he or she is faced with integrating these tools into one working system. The claimed invention provides a method and system for integrating and accessing these tools and functions. In one embodiment a method using an open architecture system allows disparate investment tools to communicate with each other real-time in a manner that is transparent to the investment manager. A central interface, using a user defined format, presents a variety of functions from a number of investment tools. This central interface allows a user to view data and result from a number of investment tools on a single interfaces as well as launching individual investment tools, populated with data that is integrated from the remaining tools. The user can design alerts to provide notification when certain criteria regarding investment parameters have been met. In one embodiment, an individual system of user defined investment tools can be coupled with other individually designed systems forming a network. In one embodiment, an application service provider serves as a host to the network allowing a user to indicate his or her willingness to offset an order with another user.

### RELATED APPLICATIONS

This application claims the benefit of U.S. Provisional Application No. 60/218,105 filed Jul. 13, 2000, which is incorporated herein by reference.

### FIELD OF THE INVENTION

The method and system presented are in the field of system integration. More particularly they are in the field of integrating tools that aid in investment management.

### BACKGROUND OF THE INVENTION

Managing an investment portfolio is a complex task. It involves the utilization of a variety of investment tools covering a wide range of functions. While an individual investor can often manage the performance of a portfolio containing a few stocks, portfolios populated with numerous different investments from numerous industry sectors causes the task of overseeing such a portfolio to become daunting. A typical investment manager must stay abreast of changing market conditions and numerous factors related to each company in the portfolios they manage. These factors include knowing a portfolio's status throughout the day as the portfolio's cash balance fluctuates and trades progress from initiation to settlement as well as changes in the risk profile of a portfolio due to changing market conditions or risk attributes.

An individual in charge of managing a portfolio must weigh risks associated with each investment as well as conduct extensive research into the company's stability, outlook, and business plan. The manager must also consider what markets to trade in and the mechanics of carrying out transactions in that market before he or she initiates an order to buy or sell securities. Investment managers balance their investment decisions against many factors including the risk profile of the portfolios they manage so as to ensure their decision is acceptable. At the same time they must remain within the portfolio's mandate. The performance of each security must be reviewed by the manager as must the performance of the combination of the securities comprising the portfolio. Given this information, the investment manager shifts assets by selling and acquiring new securities. The manager strives to remain informed of the status of these transactions as well as the cash flow and liquidity of the portfolio as assets change hands. Finally, the entire process must be tracked for error conditions that could adversely affect the performance of the portfolio and an extensive accounting system is used to ensure credit and risk assessments are properly allocated.

Today, companies and institutions of all types are often involved in the management of large investment portfolios. This management is a complex task which is shouldered by numerous parties. These parties include but are not limited to portfolio or plan sponsors, the investment managers, hedge fund managers, mutual fund managers, insurance companies, as well as committees that oversee foundations, endowments and pension funds. This complex and diverse environment has produced many specialized professions including that of the investment manager.

To aid an investment manger in the complex world of trading, evaluating, and negotiating the sales and purchases of securities, various vendors have produced products to assist the manager in making his or her day to day decisions. Many vendors produce individually tailored products to aid an investment manager in risk management, data and market research, portfolio accounting, portfolio performance and management, trade order management, and more. While many of the capabilities of these investment tools overlap, each possesses strengths that attract different users. Consequently, investment managers use an ad hoc combination of traditional investment tools that individually perform exceptionally well but interact poorly.

As managers individually interact with each investment tool, they must manipulate the information provided by each tool to optimize their functionality. Terms and codes used for the same security or financial indicator may be different for different investment tools. To compensate, the manager must create and maintain an extensive list of translations, definitions and conversions. This task of such manual integration is necessarily rigorous, time consuming, inefficient and prone to errors. For example a manager may conduct extensive research concerning a company to determine if an investment is warranted. After gaining that information the manager may wish to examine the effect of such an investment on the risk of the portfolio using the information just obtained. To do so the manager must convert the data to a form that is compatible to both investment tools and then enter the information into the risk management investment tool for analysis.

Armed with this information the manager can move forward, ensuring compatibility of terms and data, and place an order utilizing another investment tool designed to interact with various markets around the world. As the transactions take place, the manager must account for his or her actions in yet another tool. The current process is inefficient. To make matters worse this process is often iterative, requiring multiple case studies and alternative combinations for each transaction. As the number of securities under the control of an investment manager grows and becomes more diverse, the complexity of managing a portfolio becomes almost insurmountable. This is further complicated with realization that managers normally control multiple portfolios.

To carry out their job, investment managers continually investigate factors that can alter the composition of the portfolios they manage. Managers must consciously remember what aspects of the portfolios under his or her control must be examined and when they must be examined. For each such inquiry the manager must gain information from multiple investment tools after inputting data as described herein. Once the analysis is complete the manager must examine the result against a benchmark or standard to determine if action is warranted. The result in an inherently dated account of an isolated aspect of the portfolio. This manual manipulation of information and data is laborious, time consuming and inefficient. Its monotonous nature breeds inattentive, apathetic, and erroneous decisions. Investment managers and other professionals, trained to maximize the value of portfolios, are currently compelled to divert their attention and resources away from the very investments they manage.

Investment tools currently fail to adequately interact with each other. While a particular vendor may produce several types of investment tools covering a wide range of functionality, an investment manager typically seeks the best product of each particular function and tailors an amalgamation of tools to his or her duties in managing a portfolio. This ad hoc combination of investment tools produced by multiple vendors often fails to have any integration or interaction capabilities. Those investment tools that do possess integration capabilities are typically proprietary and do so in a manner that leads to multiple links with multiple investment tools leading to a spider web of couplings and integration protocols.

FIG. 1 is a block diagram of a typical configuration of a plurality of investment tools showing a number of multiple links for each investment tool. In a typical configuration of investment tools, each investment tool 101-108 provides some means of integration to other investment tools. The links 110 between the investment tools 101-108 and the user interface 112 creates a combination of links and communication channels requiring each investment tool and the user to maintain a library of rules and data from the remaining tools. While most programs from the same vendor support such communication, competing vendors often fail to provide adequate links. The system shown in FIG. 1 shows a link between each investment tool 101-108 and the user interface 112 except between investment tool 102 and investment tool 105. In this case, information specific to investment tool 105 is unavailable to investment tool 102 unless they communicate through a third investment tool or through the user interface 112. While this embodiment shows a total absence of a link between investment tool 102 and investment tool 105 it is also possible that only a limited link is supported by the translation rules provided by each vendor. The user is faced with multiple interfaces with several different types of nomenclatures and outputs. The result of such a system is a reduction of efficiency in the managerial process, an increase in the likelihood for errors, and expensive delays in conducting time critical transactions. Furthermore, should a user elect to replace or add an investment tool, a great deal of effort and time must be expended to re-engineer the links and data mapping between the new investment tool and the remaining investment tools.

Data from the individual investment tools is delayed. An investment manager must accomplish several steps in the operation of each investment tool to gain information. As each tool is independent of the other, no consistent real-time source of investment data is available to the investment manager. Data is delayed by the time taken for a manager to access and operate an investment tool and to manipulate the data into a useful form by using other tools.

Current systems also fail to provide investment managers and investors with adequate evaluation data or transactional reports. To properly evaluate the performance of a portfolio, investors and investment managers need to gain near real-time performance summaries and attribution information. Few systems provide such availability. Once a manager has reviewed the available information and made a decision to buy or sell a security, a trader is notified who has several options on how to carry out the transaction.

In addition to the traditional avenue of using a trader to contact a stockbroker to execute an order on the user's behalf, the trader can also utilize electronic crossing networks. The use of these systems removes the stockbroker from the transaction resulting in a considerable reduction of costs. These systems try to match orders from throughout the world. However, current crossing networks described herein require an order to be placed for a certain period of time. When an order is placed on a crossing network in search for a possible match it is out of the control of the trader or user who placed it there. During the time that the order is idle, the market could change resulting in what was a favorable transaction at the time the order was placed in the crossing network becoming a losing proposition. There is a loss of control regarding the disposition of the order. There is no guarantee that the cross will occur, as an offsetting transaction must be matched for the order to be carried out, nor may an order be arraigned at an exchange. Thus current crossing networks pose a considerable risk to the investment manager who authorizes such action by a trader. The dynamic nature of today's market demands that managers be aware of minute by minute changes in the marketplace as well as the trader's corresponding interaction.

An investment manager or the investor cannot currently determine with any degree of confidence the value of the portfolio they are managing on a real-time basis. Sales and purchases of securities carried out by a trader can currently take days to close after the order is initiated. While the value of the transaction, once executed, is reasonably certain, the liquidity of the portfolio is reduced by the amount of the trade until the transaction clears. This can prevent the manager from making desirable subsequent trades or transactions, based on current market conditions, due to lack of liquid assets. Likewise, a manager, having placed an order, is powerless to monitor the status of the transaction once it is in the hands of another party. The investor and investment manager are at the mercy of a convoluted and inefficient system that deprives them of critical information regarding the essential nature of their business.

### SUMMARY OF THE INVENTION

A method and system for investment integration are presented. Various embodiments enable functions of a group of investment tools, chosen by an investment manager, to be combined for use with a central user interface. One embodiment includes a method for integration of investment tools with a hub and spoke architecture in which a single central interface integrates the functionality of the various investment tools. The hub and spoke architecture, in one embodiment, includes a single link between each investment tool and the central interface. This simplified design eliminates the need for multiple links and facilitates the user's selection of alternate investment tools. In an embodiment of the claimed invention, various investment tools are preintegrated to the central interface thus providing the user with flexibility and increase selection when creating or modifying his or her investment tool suite. Once integrated, the central interface allows the various tools to pass data amongst each other with no interaction by the user. The transparent nature of the integration lets each investment tool benefit from the specialized capabilities of the other investment tools yielding an improved source of information on which the investment manager can base his or her decisions.

Along with integrating the functionality of the various tools utilized by an investment manager, one embodiment enables the user to monitor the investment process. Such monitoring including the status of interactions between the investment manager and the various vendor-provided investment tools that the manager employs to manage his or her portfolio. An alert can be established to notify the user when pre-established criteria are met. This alert is identified on the single user interface for easy recognition. The status of the parameter can additionally be monitored on a real-time basis even if the alert has not been triggered, giving the investment manager up to date data on which to base his or her decision.

The ability to facilitate electronic crossing is provided in another embodiment. One embodiment of the claimed invention includes establishing an aggregation of multiple client spoke and hub systems using an application service provider. This aggregation can allow users to access real-time order flow information of other participating users. With this information available transaction matches and crosses can be accomplished without exposing the portfolio to current crossing limitations and risks.

### BRIEF DESCRIPTION OF THE FIGURES

The present invention is illustrated by way of example in the following figures in which like reference indicate similar elements. The following figures disclose various embodiments of the claimed invention for purposes of illustration only and are not intended to limit the scope of the claimed invention.

FIG. 1 is a block diagram of a typical prior art configuration of a plurality of investment tools.

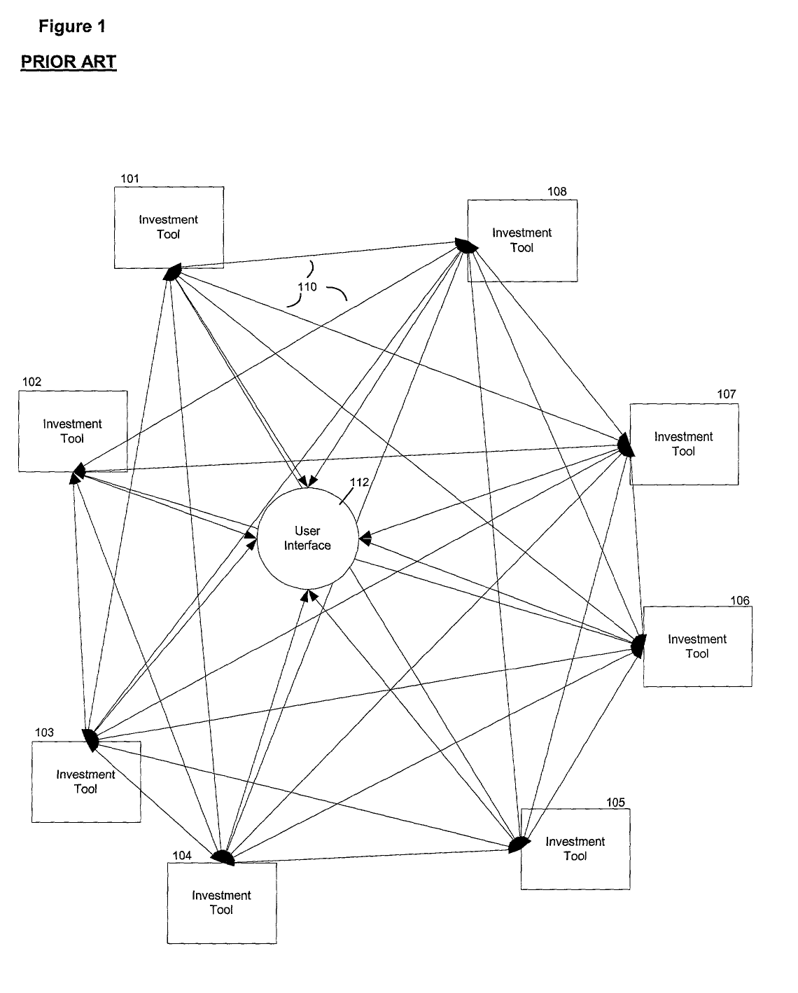

FIG. 2 is a block diagram of an embodiment of a system for integrating investment tools illustrating a hub and spoke design.

FIG. 3 is a block diagram of an embodiment of a network system for integrating investment tools.

FIG. 4 is a block diagram of a system architecture of an embodiment for a system for integrating investment tools.

FIG. 5 is a flow diagram of an embodiment of the integration process of a plurality of investment tools.

FIG. 6 is a block diagram of an embodiment of a method and system for integrating investment tools for a thick client using envelope applications.

FIG. 7 is a block diagram of an embodiment of a method and system for integrating investment tools for a thick client using a batch process.

FIG. 8 is a flow diagram of an embodiment of a method for integrating investment tools showing a possible user developed workflow.

FIG. 9 is a flow diagram of an embodiment of a method for integrating investment tools, illustrating the individual launching of an investment tool.

FIG. 10 is a flow diagram of the monitoring process of an embodiment for integrating investment tools.

FIG. 11 is a flow diagram of the reporting process of an embodiment of a method for integrating investment tools.

FIG. 12A is a flow diagram of crossing transactions using an embodiment of a method for integrating investment tools.

FIG. 12B is a block diagram of a aggregation of hub and spoke architectures of an embodiment of a system for integrating investment tools illustrating a crossing network.

FIG. 13 is a depiction of an embodiment of a method and system for integrating investment tools illustrating a security view of a user interface.

FIG. 14 is a depiction of an embodiment of a method and system for integrating investment tools illustrating a stock watch view of a user interface.

FIG. 15 is a depiction of an embodiment of a method and system for integrating investment tools illustrating a portfolio view of a user interface.

FIG. 16 is a depiction of an embodiment of a method and system for integrating investment tools illustrating a portfolio watch of a user interface.

### DETAILED DESCRIPTION

A method and system for investment integration are described. Managing an investment portfolio involves the use of a number of investment tools. One embodiment includes integrating these investment portfolio management tools. Each tool possesses unique capabilities that aid an investment manager in carrying out his or her job. Examples of these tools include portfolio analytic systems, portfolio accounting tools, risk management tools, data research tools, trade order management tools, and performance measurement and attribution systems. As investment managers review the many available options, they fashion a suite of investment tools suited for their particular needs. It should be noted that while the term investment manager is used frequently in describing the embodiments that follow, the methods and system described herein are not limited to use by professional investment managers. To facilitate this understanding, the term user is often used interchangeably with investment manager.

One embodiment of the claimed invention includes a method for integrating multiple investment tools that perform distinct functions. A single user interface combines the analytical results of these investment tools into a predefined user format. A user, in one embodiment, fashions a display of critical and support information in a manner that is suitable for his or her individual needs. Transparent to the user, the investment tools communicate information via a central hub or central interface. In one embodiment a hub and spoke architecture is used to facilitate this integration.

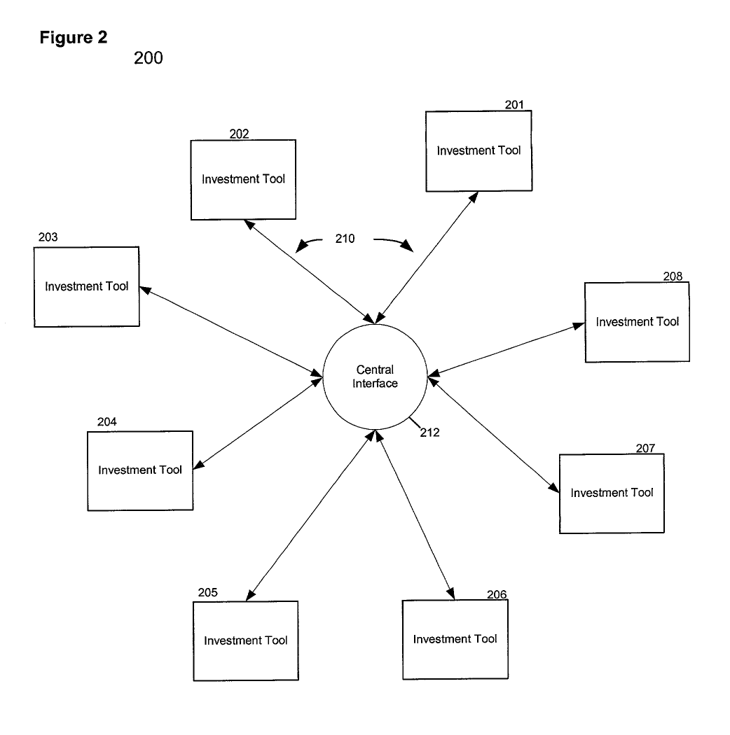

FIG. 2 depicts an embodiment of an integrated system of investment tools. Integrated system 200 has a hub and spoke architecture in which each investment tool 201-208 is linked 210 with a central interface 212. The central interface 212 includes a user interface and several servers to maintain a depository of the rules necessary to translate the data coming from each investment tool as well as the data itself. In addition to storing the rules of integration for the investment tool individually identified by an investment manager, the central interface, in one embodiment, comprises additional translation rules of multiple investment tools produced by multiple vendors not included in the current configuration. The translation rules of the investment tools, both those chosen by the investment manger and those not included in the current configuration, are maintained and updated periodically.

This architecture establishes a system where the number of links between individual investment tools is substantially reduced. Each investment tool includes a single link to the central interface 221. The central interface 212, in one embodiment, is a common focal point of interaction between the investment tools. Should an investment manager wish to change from one vendor's investment tool to another investment tool, the integration of the new investment tool is transparent to the user and only requires establishing one link to the central interface 212. The additional vendor investment tool is pre-integrated allowing the user to plug into the alternate tool seamlessly. This plug in effect increases the flexibility of the tools available to the user and helps a user tailor the system to his or her needs. Creating a central interface 212 consolidates the interaction in one location minimizing the number of links and duplication of resources.

In one embodiment an open system architecture allows a user to define the structure of a system of investment tools he or she will be using as well as allowing for real-time data transfer. The open nature of the architecture can be accessed by vendors to facilitate integration with the central interface and other investment tools. Rules needed to developed integration methods can be provided to produce a uniform system of links between various investment tools and a central interface increasing the overall selection of investment tools available to the user. The custom nature of the system structure allows a user to adapt a work flow that facilitates his or her specific investment portfolio management style. Since all the resources of all the investment tools are available to the user at the central interface, the investment manager is no longer constrained with artificial barriers between the functions of different investment tools. In another embodiment the user can direct different aspects of the investment tools to conduct real-time analysis of multiple aspects of the investment portfolio without individually interacting with each investment tool. The user can focus on managing the portfolio rather than managing the investment tools.

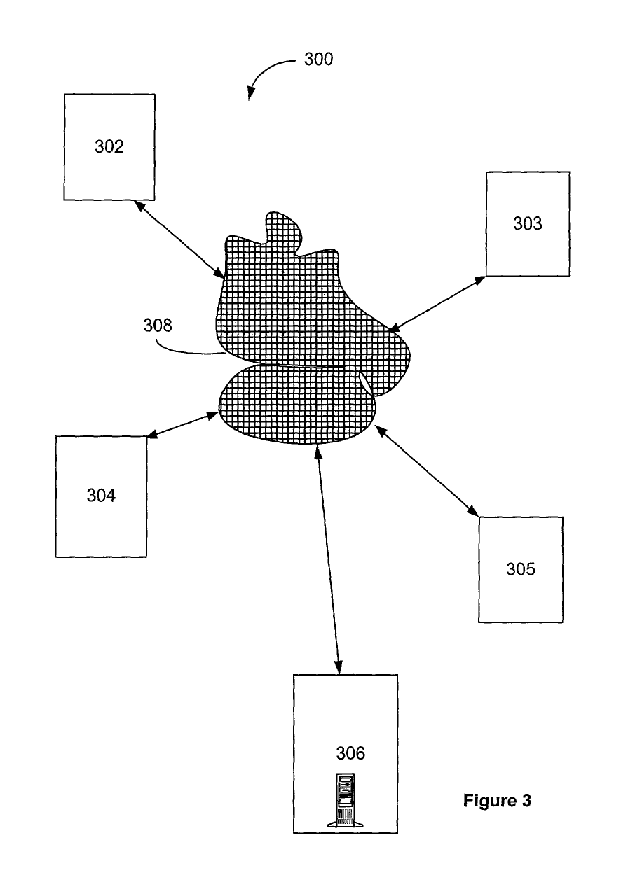

FIG. 3 is an embodiment of a system 300 for integrating investment portfolio management tools. The system includes multiple client computers 302-305, that are coupled to the server 306 through a network 308. The network 308 can be any network, such as a local area network, a wide area network, or the Internet. The client computers each include one or more processors and one or more storage devices. Each of the client computers also includes a display device, and one or more input devices. All of the storage devices store various data and software programs. In one embodiment, the method for integrating investment portfolio management tools is carried out on the system 300 by software instructions executing on one or more of the client computers 302-305. The software instructions may be stored on the server 306, or on any one of the client computers. Software instructions can be stored on the server and accessed through the network by a client computer operator or investment manager. In other embodiments, the software instructions may be stored and executed on the client computer. The user of a client computer with the help of a user interface can enter data required for the execution of the software instructions. Data required for the execution of the software instructions can also be accessed via the network and can be stored anywhere on the network.

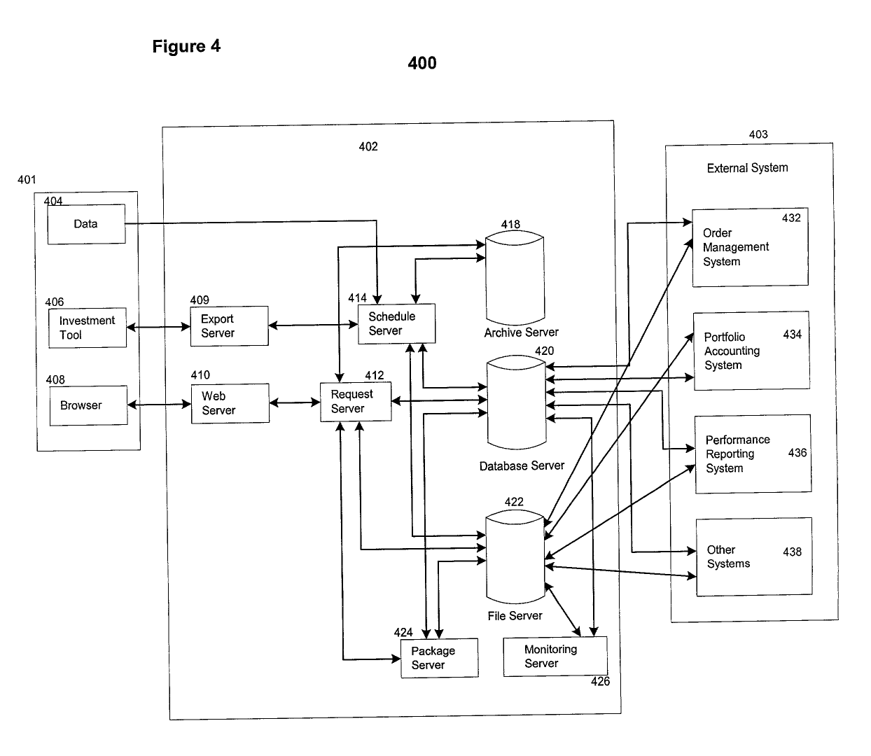

FIG. 4 is an embodiment of a system architecture for integrating investment portfolio management tools. The system architecture 400 is composed of external exponents 401, an infrastructure 402, and external systems 403. The infrastructure 402 incorporates, in one embodiment, an array of servers and databases. The external exponents contain data 404 from an outside source including a user, a user application program 406, and a browser 508. The infrastructure includes an export server 409, a web server 410, a request server 412, a schedule server 414, a package server 424 and a monitoring server 426. Also associated with the infrastructure are storage devices including an archive server 418, a database server 420, and a file server 422. The database server 420 and the file server 422 are linked to the external systems 403 including an order management system 432, a portfolio accounting system 434, a performance reporting system 436, as well as other systems 438. The servers within the infrastructure 402 communicate with each other so as to facilitate the integration of data and functionality of the external systems. The architecture is scalable because it supports an arbitrary number of components for each function and the number of components can be adjusted based on system requirements.

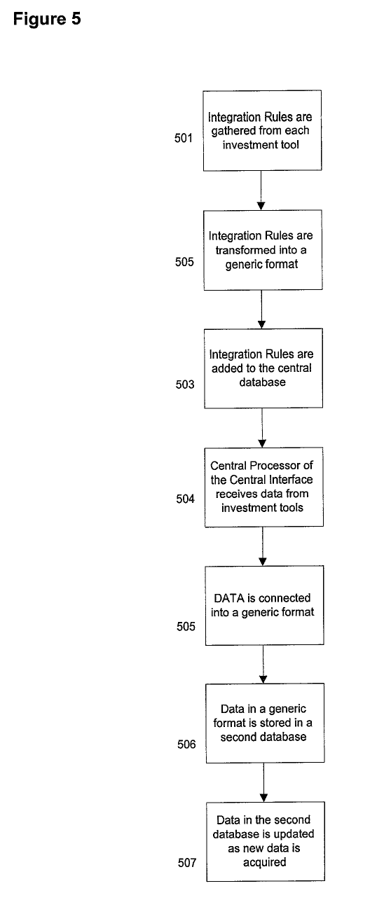

FIG. 5 is a flow diagram of an embodiment showing the integration process of a plurality of investment tools. Each investment tool performs specific functions that facilitate the investment process. Because the investment tools are specialized, the vendors of the investment tools provide rules, or hooks as they are sometimes called, to aid in the integration process. These rules allow one program to communicate with another program. When a vendor develops the code for an investment tool it determines what internal symbols and nomenclature will be used to represent numerous variables. The rules associated with these variables are provided to other programs to allow like variables, that are represented by different symbols in different programs, to be treated equivalently. Information such as the terms used for specific variables and format parameters are provided so that a user of another investment tool from the same or a different vendor can combine the tools' capabilities. For example, rules may exist that allow Thomson OpenTrader™ to exchange data with Advent Axys™ as well with FMC Sylvan™.

The embodiment of an integration method depicted in FIG. 5 begins by gathering the integration rules 501 for each function in an investment tool. Once gathered, the rules are transformed 502 into a generic format. A format such as XML can be used to facilitate the ease of transformation and optimize versatility. The transformation of the hooks into a common language provides a generic source of rules that the integration process can use to consistently integrate the various investment tools. The new generic rules are added to a central database 503 and stored along with rules in the same format from other investment tools. As a particular investment tool performs one of its functions and produces data useful to either the user or other investment tools, the data is transmitted to and received by a central processor 504. Since the data produced by each investment tool contains signature properties which identify the source of the data, the central processor 504 retrieves the rules from the central database 503 that corresponds to that investment tool, and converts the information 505 into data that can be uniformly understood and used by all the investment tools. In this manner the investment tools communicate with each other without the user being aware that the communication is taking place. Once translated the data is stored, in one embodiment, in a second database 506, for easy retrieval. As new information is acquired, the data is updated 507 giving each investment tool, and the user, access to the most current and accurate data. Because all the investment tools communicate with a central processor, multiple links between the investment tools are eliminated.

In another embodiment individual investment tools are integrated through the use of web applications. These investment tools are called thick clients and use interaction software including C++ and VB. When a user elects to use a vendor tool that is a thick client, a new web window opens allowing the user to interact with the vendor specific investment tool. Using Microsoft Terminal Service's™, a user can interact with this investment tool running on a remote server and displayed over the internet in a web browser window.

In this embodiment of the claimed invention, data is exchanged between a holdings database and the investment tool. One method of accomplishing this is for the envelope application to extract data from the holdings database and supply the investment tool with needed information. As the user uses the investment tool the envelope application saves data to the holdings database. Another embodiment integrates thick clients using a batch approach. A batch application continually extracts data from and saves data to the holdings database. Summary reports generated by the investment tools are converted to XML, HTML or other formats known to one skilled in the art and made accessible to the holding database and the integrated system directly from the web application.

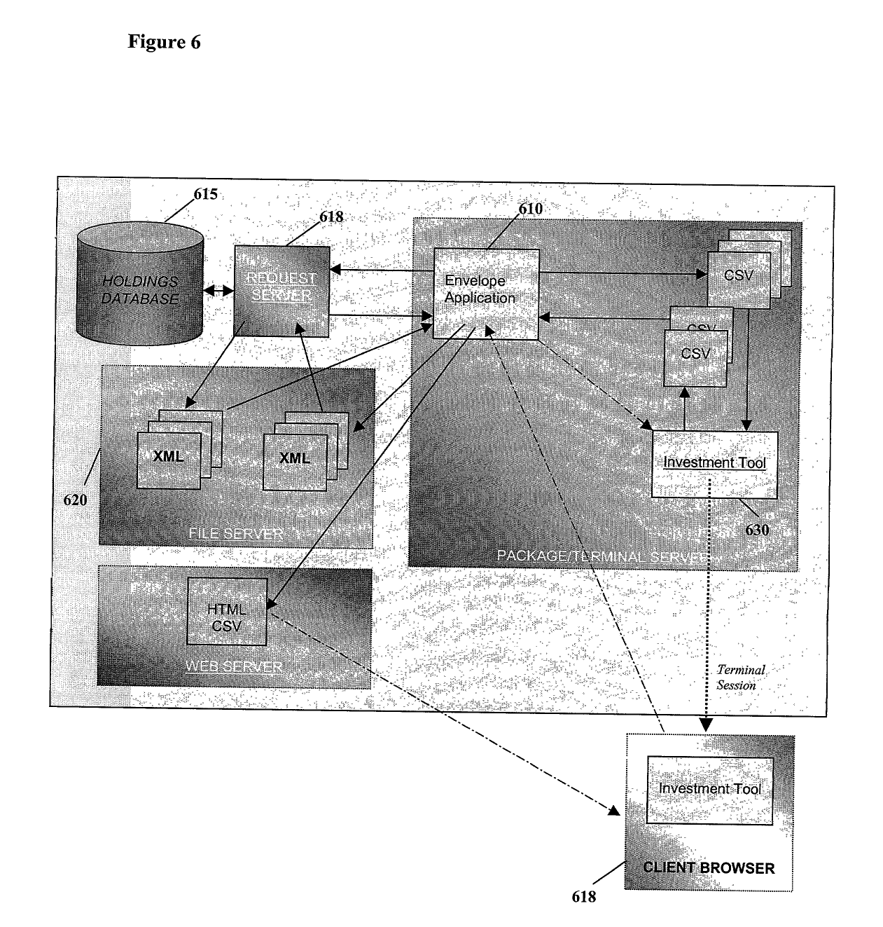

FIG. 6 is a block diagram of an embodiment of a system for integrating investment tools depicting the integration of a thick client. Application service providers 605 automatically log onto a terminal server to launch the appropriate investment tool envelope application 610. The envelope application 610 extracts data from the holdings database 615 by sending a request to the request server 618. Data retrieved from the holdings database is maintained in a standard format including XML. Data from the holding database 615 conveyed to a web site 620 where it is converted to the XML or similar format. Input data is then placed in the application envelope 610 and converted to the format expected by the investment tool including comma-separated values (“CSV”). The envelope application 610 launches the investment tool 630 and populates the investment tool 630 with the CSV files containing the input data. Output from the investment tool, also in CSV format, is sent to the web site 620 through the envelope application 610. The envelope application 610 converts the CSV data to XML or other similar standard format and places it in the holdings database 615 for storage. Reports of the data produced 640 by the investment tool are also available through the envelope application 610.

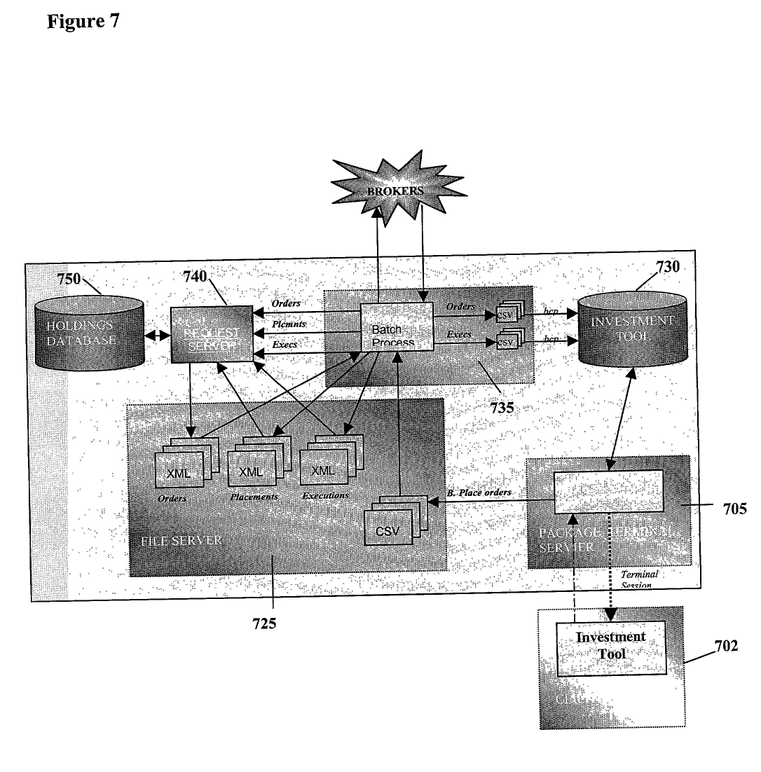

FIG. 7 depicts an embodiment for a system to integrate thick client investment tools using a batch process to place. The thick client depicted in FIG. 7 aids investment managers in placing orders to buy or sell securities. An application service provider 702 logs onto a terminal server 705 and launches the investment tool 730. A placement file is generated on the file server 720 and forwarded to the batch process 735. The orders originating from the terminal server are in CSV format. Orders are processed by the batch server 735 creating requests for data. The requests are forwarded to a request server 740 which retrieves data from a holdings database 750. The data is converted from XML or another standard format to CSV format at the file server and them returned to the batch server 735. Orders and executions are sent to the investment tool using, in this embodiment, a bulk copy (“bcp”) operation. This includes orders originating from the user and executions originating from a broker. For example, executions from a broker arrive at the batch server 735 and are converted to CSV format. The execution order is delivered to the request server 740 and converted to XML at the file server 725 for storage in the holdings database 750. The order is also delivered to the investment tool 730 using a bcp operation in CSV format.

Thin clients are another type of investment tool that can run locally on the client machine and can interact intimately with a client possessed web browser. Integration for these types of clients, in one embodiment, includes customizing the web browser to prepare data so that it is compatible with the investment tool.

Each investment tool is unique and correspondingly possess unique integration tasks. In one embodiment of a method of investment integration the individual investment tools are broadly categorized to nine different areas. These areas include market data, portfolio analytic, order management, trading links, reconciliation, analyst data, portfolio accounting, performance reporting, and risk management. Specialized programs are produced in another embodiment that stops processes running on the package servers as well as latches an un-latches the package server's exclusive access protocols. Furthermore, programs are developed for launching, monitoring, and controlling investment tools running on the package server. Once an investment tool has been grouped into a category, the required interfaces are determined as well as whether data is input, output, or both. In one embodiment integrating order management tools, the integration process must input data from interfaces including holdings, external orders, security identifiers, security prices, order cancellation sand revisions, and execution of cancellations and revisions. It must also output order cancellations and revisions, execution of cancellations and revisions, assignment allocated executions, and internal orders.

After it is determined what data must be manipulated, a list of steps, unique to each category of investment tools, can be developed to incorporate that particular category to the integrated system. An order management tool's incorporation begins with extracting new orders from a central database. The orders are used to create an input file and the data is input into the appropriate investment tool. Once the tool is populated with data, the integrated system monitors the investment tool to detect if the order is assigned to a broker. The databases are further monitored to see if the broker has carried out any executions or allocations. If any allocations occur, the data is exported from the investment tool to the integrated system database.

Portfolio analytic tool's incorporation begins with the portfolio holdings, prices, and benchmark data being retrieved from the central database. The data is converted from the format that it is stored in, XML or a similar format, to a format compatible with the investment tool such as CSV. The investment tool is launched and the data, now in compatible format, is used to populate the tool for use. The output of the investment tool is converted to XML or the format used for storage and input into the central holdings database. The report of the output is then copied to the central interface web page for display. Similar processes can be developed for the other categorized listed herein.

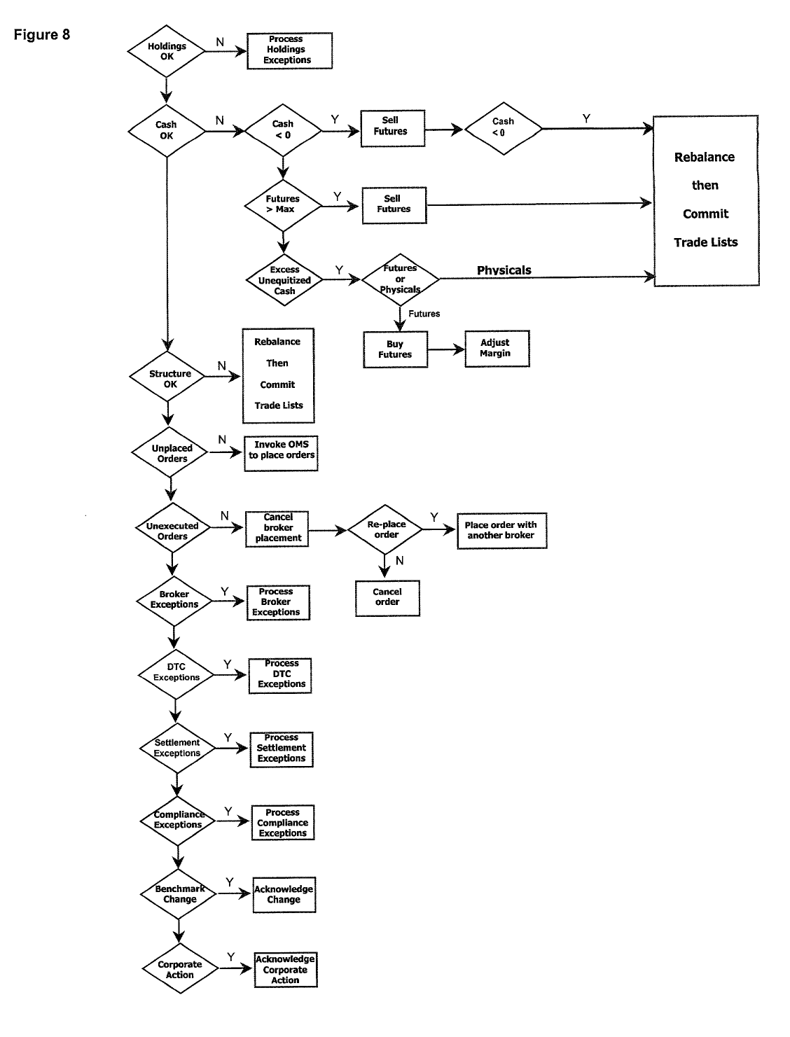

Once the categories of investment tools are incorporated to the central system, a work flow is developed by the user to manage the multiple inputs and outputs from various investment tools. FIG. 8 is a flow diagram of one embodiment of a method for integration of investment tools showing a workflow developed by a user to manage inputs and outputs from various investment tools.

The versatility of the hub and spoke design combined with the aforementioned architecture provides a user with increased flexibility regarding what investment tools he or she wishes to utilize. In one embodiment a user can select investment tools such as portfolio analytic systems, portfolio accounting tools, risk management tools, data research tools, trade order management tools, and performance measurement and attribution systems. Each of these types of tools is produced by multiple vendors and comprises unique functions.

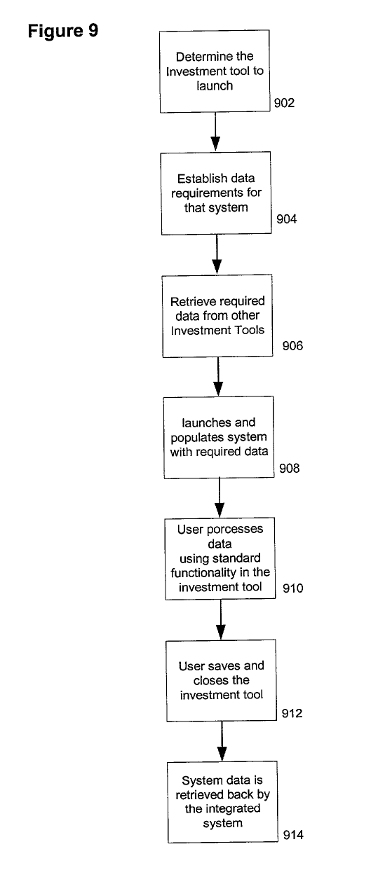

While the data from each of these systems is transformed so as to be available to the remaining systems in a manner that is transparent to the user, the user may still wish to operate and interface directly with an individual investment tool. In one embodiment the user can launch the investment tool from the central user interface with the common data already populated into the investment tool. FIG. 9 is a flow diagram for launching an integrated investment tool of one embodiment. The launching of an investment tool 900 begins with the user selecting the tool to launch from the central user interface 902. Once identified, the integrated system determines the data requirements for that particular investment tool 904 and retrieves the required data from other investment tools within the integrated system 906. With the data requirement determined, the integrated system launches the investment tool and populates the tool with the required data 908. The user then conducts whatever processes he or she desires using the standard functionality of the investment tool 910. Once the user has completed using the investment tool, the user saves the data and closes the investment tool 912 while the integrated system retrieves updated data from the investment tool and updates the integrated database 914.

Investment tools carry out a wide variety of investment functions. Portfolio analytic systems for example can include systems that allow investment managers to use analytic tools to analyze, optimize and re-balance their portfolio using advance mathematical tools. Tools conducting portfolio accounting allow a user to track holdings and transactions of a portfolio as well as perform cost accounting and other reporting functions. Tools focusing on risk management run algorithms analyzing the portfolio to determine a measure of risk using industry standard terms and values as well as offering options to the investment manager that would minimize the portfolio's exposure to risk. Research data tools perform various research functions. For example, some research data tools collect and catalogue research documentation from analysts regarding individual securities and combinations of securities as well as provide tools with which the user can browse data libraries. Trade order management tools handle the order execution process and manages the dialogue between the investment manager and the brokers executing the orders. Generating historical performance of a portfolio, measured against defined benchmarks, is one function of a performance measurement and attribution system. As the performance of a particular portfolio is measured, the system attributes either poor or favorable performance to different causes providing the user with helpful feedback and guidance on how to better manage the portfolio.

As described herein, the functions carried out by the investment tools are very specific and diverse. Consequently, depending on the particular combination of investment tools, the portfolio management system for a particular user may possess little to no redundancy. Furthermore the user interface for each tool are often different, as are the commands and inputs. One embodiment of a method and system for integration of portfolio investment tools provides a user with a central interface where data from several investment tools is presented in a uniform format designed by the user. The information provided by each investment tool is blended together in a manner that makes sense to the investment manager. Providing information obtained from different investment tools side by side in one embodiment allows an investment manager to visually see the interaction between the values.

The integration of the data from the individual investment tools to the user defined uniform format is transparent to the user based on the translated rules and databases described herein. Should a user wish to interface with the investment tool directly, the central user interface allows a user to launch the investment tool. Parameters and data specified in the central user interface are transferred to the investment tool to populate the investment tool. Once launched, the user may work using the investment tool interface or the central interface with data acquired during the process remaining available to the user upon completion of the work either through the investment tool itself or the central interface.

A further embodiment allows a function performed by an investment tool to be monitored by a user. Functions including portfolio optimization, re-balancing, risk assessment, trade order execution, and portfolio performance and attribution can be monitored by the user through a user interface. As described herein, monitoring the results of a function performed by an investment tool is very monotonous and time consuming. In one embodiment the user establishes criteria that, when exceeded, causes the process to notify or report to the user that an event, input by the user, has occurred. The criteria and process specified by the user can include a number of steps and interaction between other investment tools thus removing from the investment manager the tedious tasks of integration and data input. The report or notification of selected results can be accomplished through a visual alert, an audio tone, or other methods known in the art. If, as in one embodiment, a visual indication is present on the user interface indicating that a specific user established criteria has been met, the user can view the data associated with that criteria by selecting the indication.

Alternatively, the user can launch the investment tool associated with that alert and review the data that resulted in the notification to be posted on the user interface. A common example of this process occurs when a specific security reaches a price at which the user wishes to initiate a transaction. The notification process, however, can be expanded to include any of the functions carried out by the investment tools. For example, an investment manager may wish to be alerted when residual risk, a value associated with non-diversified risk of a portfolio, reaches a particular value. This value is determined through an intricate combination of portfolio composition, market indicators and other parameters examined by many different investment tools. As the market shifts or composition of the portfolio is altered, residual risk may raise beyond a desired value indicating to the investment manager that a careful look at the portfolio is warranted.

Another embodiment of the monitoring process allows a user to review intermediate values of functions carried out by an investment tool. Associated with a user setting criteria when they wish to be notified, the user can direct a function of one of the investment tools to operate periodically. If during the periodic completion of the specified function the notification criteria are met, the user is altered as described herein. However, if the criteria are not met the values of the functions completed by the investment tool remain available for review by the user. In one embodiment, the user can select a particular function and view the value last determined by the function. Continuing with the previous example regarding residual risk, the user can periodically review the value of residual risk as determined by one of the investment tools to see if any unfavorable or favorable trends are occurring. Given such information, the user can make informed decisions regarding investment portfolio management.

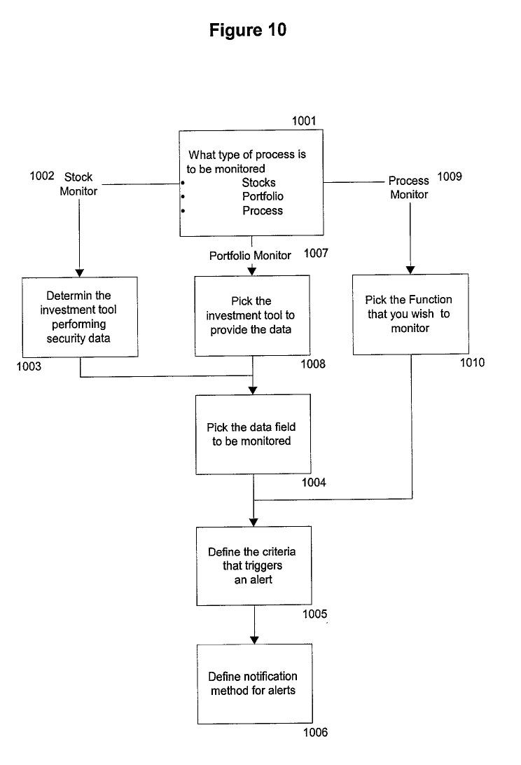

FIG. 10 is a flow diagram of an embodiment showing the monitoring process of investment tools. The monitoring process begins with the user determining which categories 1001 of the investment management process the investment manager wishes to monitor. In the embodiment illustrated in FIG. 10 these categories include stock, portfolio, and process monitoring. For example stock monitoring 1002, requires the investment tool dealing with security data be selected 1003. With the investment tool identified, the field to be monitored is selected 1004. User defined criteria initiating an alert are determined 1005 and the method of a notification is specified 1006. In the situation where a portfolio is selected to be monitored 1007, the investment tool that will provide the desired information is chosen 1008 and the data field within the investment tool is determined 1004. Again, the user provides specific criteria determining when an alert will be generated 1005 and how the alert will be delivered 1006. Likewise, if a process is being monitored 1009 a function from within a particular investment tool is identified 1010. Criteria directing the process to generate a report to the user is supplied 1005 and the delivery method selected 1006.

Reports depicting the performance of a portfolio and the processes performed by the functions of the associated investment tools are included in an embodiment of the claimed invention. Using a uniform format defined by the user, a report of the results of any number of investment tools can be presented to the user for analysis. Since all the data provided by the investment tools is converted to a common format, the information is available to the user seamlessly. Furthermore, the level of completion of a function can also be reported to the user.

An illustrative example of this capability is the initiation of a trade order by an investment manager to a broker or a trader. Typically an investment manager contacts a trader through an investment tool specializing in trade orders. Once the order has been placed, the trader conveys the information to the market through a stock broker to either sell or buy a security. From the time an order is initiated by the investor to the time the trade actually takes place on the exchange, market conditions can shift making the original order unfavorable. If the broker is efficient and the user represents an influential client, the transaction may take place quickly where fluctuations in the market have little impact. However, should the user not be in such a position to exert influence on the priorities of the broker or if the market is undergoing major alterations, the actual sale or purchase price may be significantly different than the price the user initially acted upon.

Using the reporting and monitoring capabilities of one embodiment, a user can determine if the transaction has occurred. For example, based on market conditions the user may elect to sell a stock because it declined to $20.00 per share. He would send a sell order to the trader informing him of the desire to sell. The trader would receive the order, contact an appropriate broker, act upon it, and return information to the trader, user, and custodian of the stock that the actual sale took place at, for example, $19.50 per share based on the current market conditions. In one embodiment the user can monitor the trading process and watch the price of the stock as it changes on the market as well as see if the sale has occurred. If the price rebounded and the sale had not been placed he can rescind the order. Or if the user noticed that the broker had not acted on the order until the price was well below the initiated $20.00 per share trigger price the user can reevaluate the patronage of this particular broker. Decisions affecting the portfolio can be made, using an embodiment of the claimed invention, as market conditions change. Furthermore, the investment manager remains accurately aware on a real-time basis of the cash flow and liquidity of the portfolio, which can be critical in deciding if additional transactions are possible.

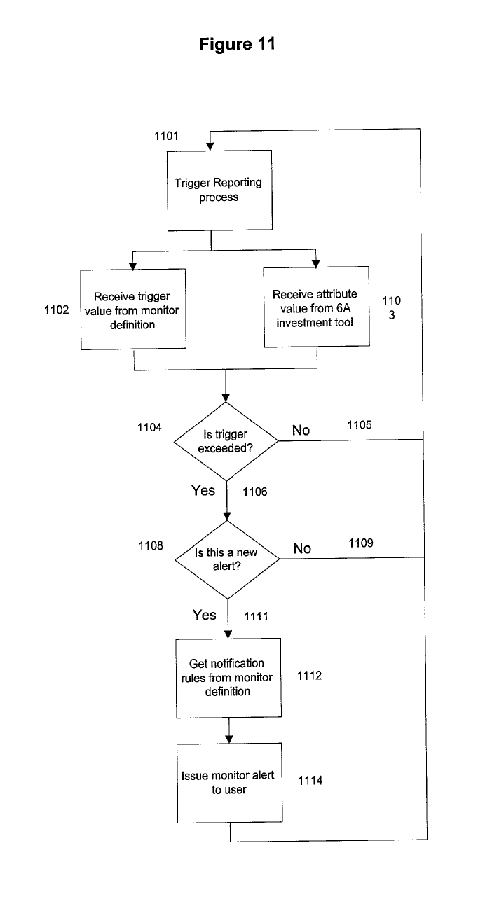

FIG. 11 shows an embodiment of a method for reporting data to a user obtained from a function of an investment tool. The reporting process 1101 receives from the monitoring process 1101 the user established criteria that would trigger an alert 1102. At the same time the process receives data from the investment tool 1103 associated with the selected monitoring category and function. The values are compared and a determination is made if the trigger is exceeded 1104. If the trigger is not exceeded 1105, the process returns to the initial step and continues to compare the values as aforementioned. If the trigger is exceeded 1106, a determination is made if the alert is new 1108. If the alert has already been posted 1109, the process again returns the comparison stage preventing redundant alerts. If, however, the alert is novel 1111 the reporting process 1101 queries the monitoring process 1001 for the display rules associated with the particular category that is being monitored 1112. The monitoring process 1001 returns the notification methods 1006 to the reporting process 1101 resulting in an alert being issued to the user 1114. With an alert issued, the process continues to compare the values but will not return redundant alerts as described herein.

In addition to reporting alerts or monitoring a function of an investment tool, another embodiment of the claimed invention facilitates crossing transactions. Crossing transactions involve using a common network to effect the trading of security orders. As described herein, when a security is typically traded an investor or an investment manager initiates an order to sell or purchase a security through a trade mechanism. On the open market these transaction occur through a stockbroker operating on an exchange. During this process the actual security is housed for safe keeping in a depository called a custodian. Custodians are normally large banks or financial institutions and have a network amongst themselves to aid in the closing of security transactions. Once the broker finds an acceptable party, an agreement is formed conveying interests in the securities in exchange for, normally, a certain monetary amount. With the transaction agreed upon, the brokers from each respective party inform the trader, the investment managers, and the custodians of what assets should be exchanged. While the agreement to convert securities typically happens on the day that the order is initiated, the actual conveyance of the security may take place several days later.

An embodiment of the claimed invention, utilizing the network system of hub and spoke architectures described herein, includes real time matching and crossing of orders. Users identify an interested party capable of making a cross thus reducing the need for a broker. In one embodiment, as the investment manager elects to submit an order to a trader, the real-time nature of the integrated system looks for offsetting matches. Matched orders can be fulfilled prior to the trader even being informed of the order. The real-time nature of the integrated system reduces any idle time normally experienced with crossing networks. Since the order is never idle on the trader's desk it may be constantly diminished or filled until the trader begins to work on the order through other trading resources. If and order has been partially filled as a result of real-time trading on the crossing network, the trader can elect to remove the remaining portion of the order and complete the residual trade on the open market.

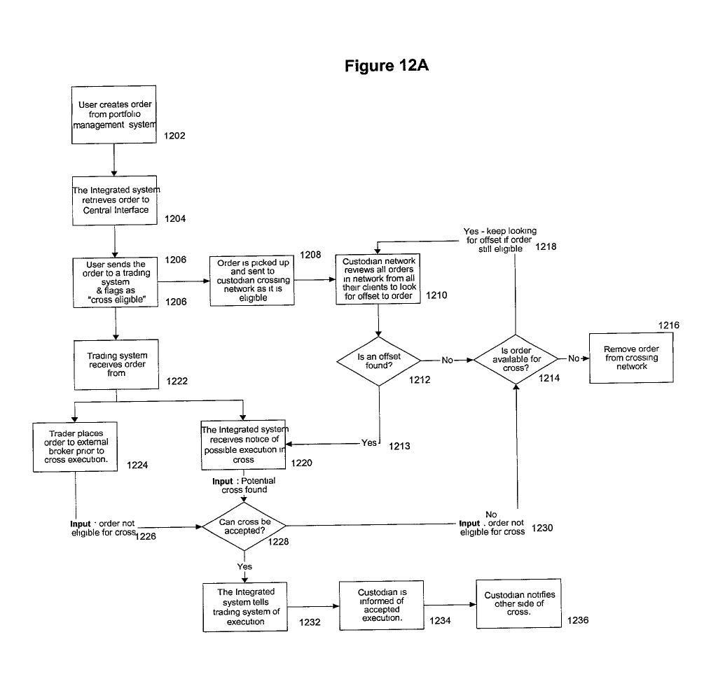

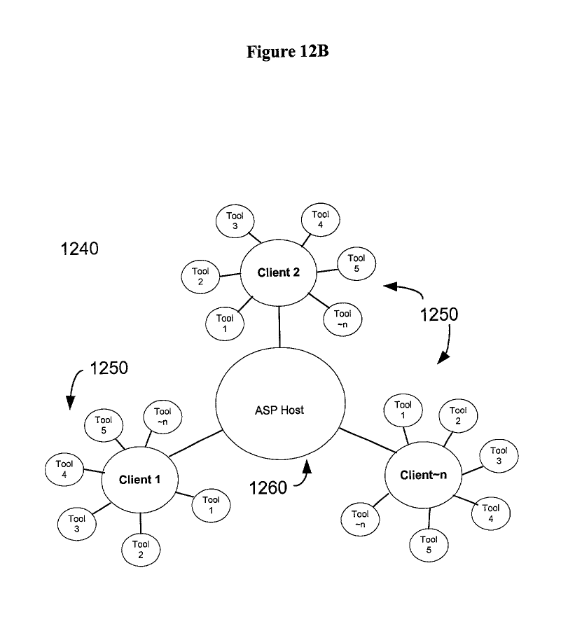

FIGS. 12A-12B show embodiments of a method and system for integration of investment tools using crossing transactions. FIG. 12A is a flow diagram of a crossing transaction of an embodiment of a method for integrating investment portfolio management tools. A user creates an order from a portfolio management system 1202 contained within the integrated system 200. The integrated system 200 retrieves the order and transfers the data 1204 to the central interface 212. The user then sends the order to a trading system, also an element of the integrated system 200, and flags the order as cross eligible 1206. The order is picked up by the crossing system and sent to a crossing network for posting as eligible 1208.

The real time crossing network reviews all the orders 1210 from multiple clients and tries to offset each order with another 1212. If an offset is not found the crossing system queries the client system to determine if the order is still available for cross 1214. If it is, the crossing system returns the order to the posting and continues to search for an offset 1218. If the order is no longer available for crossing, it is removed from the crossing network 1216. If an offset is found 1213, a message is sent back to the integrated system of the originating user notifying the user that a possible cross has been located 1220.

Once a cross has been located, the integrated system queries the user if the cross is acceptable 1228. If the cross is not acceptable the integrated system sends a message back to the crossing network that the cross is not acceptable 1230 and to continue searching for a match. The crossing network then confirms that the original order is available for a cross 1214, if it should remain posted as eligible 1218, or if the order should be removed from the crossing network 1216. If the cross is acceptable the custodian of the security is informed 1234 and the integrated system notifies the opposing party of the acceptance. The crossing transaction is completed 1236 and the custodians exchange the appropriate security. If the transaction completes only a portion of the order, the order is updated and the availability 1214 and eligibility 1218 of crossing the remaining portions of the order is confirmed and resubmitted.

At any time the trading system can be directed by the user to place the order on the trading system 1222 and remove it from the crossing network 1216. During this time the order is not available for crossing yet remains in the system until it is removed by either the trader or user. At this point the trader directs an external broker to see if he or she can find a buyer for the residual order 1224 on the open market. If the broker finds a buyer, the broker sends a message back to the integrated system that the order has been completed and is no longer available for crossing 1226 and the order is removed from the crossing network 1216.

One embodiment establishes a real-time network capable of carrying out crossing transactions by aggregating multiple hub and spoke architectures of investment tools with an application service provider performing as host. The host of the network can act as a facilitator to the crossing process establishing real-time matching to other user participants in the network. FIG. 12B is a diagram of an embodiment of a system for integrating portfolio investment tools showing a system including an aggregation of hub and spoke architectures 1240. Each hub and spoke architecture 1250 is coupled to a crossing host 1260 that facilitates establishing crossing transactions. As the number of hub and spoke architectures 1250 increase, the likelihood that the host can complete a crossing transaction is improved.

In another embodiment the integrated system network described herein can facilitate loaning of securities. Just as securities may be sold and purchased as described herein, securities can be loaned. Normally a prime broker acts as a broker between the borrowing party, those in need of the security, and the lending party. The network described herein bridges the gap between the lender and the borrower and includes the opportunity to eliminate the broker and associated fees. The integrated system can allow a user to view an inventory of securities available for loan by the host of the network. The host of a network can also view the users order flow and determine their borrowing needs thus identifying the availability of specific securities to that user.

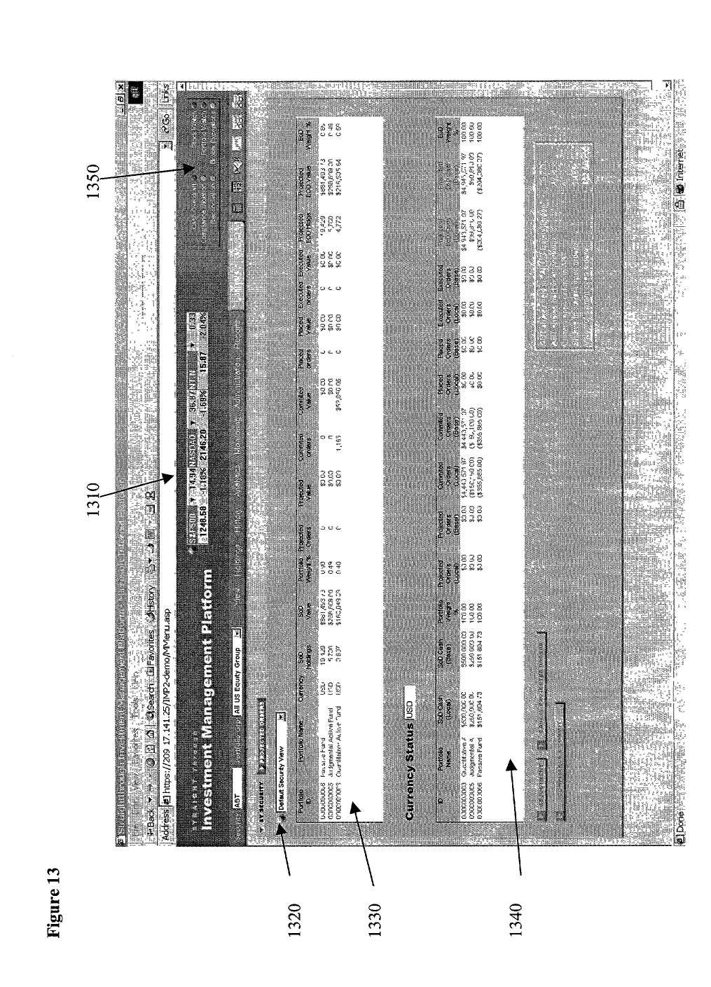

FIGS. 13-16 are depictions of embodiments of a method for integrating investment management tools illustrating various user interfaces. FIG. 13 is a depiction of an embodiment of a method for integrating investment tools illustrating a by security view of a user interface. The by security view 1320 allows securities to be modeled across portfolios and groups of portfolios with a real-time view of the holdings. Incorporated in this user interface is an ability to customize the view. In this depiction the user has elected to display a real-time depiction of three exchanges indexes 1310. Located to the right of the index display are visual displays used to notify the user of alerts which the user has predefined 1350. In this embodiment the alerts are represented by green lights that change to red once the alert criteria has been met. If the user wishes to launch a particular tool associated with the alert, the integrated user interface allows the associated system to be accessed through a drop down menu attached to the alert symbol.

The first of the two large windows depicts a start of the day holdings summary 1330. The holdings are initially populated from the historical database and integrated with data from the trade order investment tool in order to ensure the user is presented with a real-time depiction of current holdings. The remaining window depicts cash position 1340 for all portfolios. As trades take place the cash levels are dynamic indicating potential problems that the investment manager can avert through careful manipulation of securities.

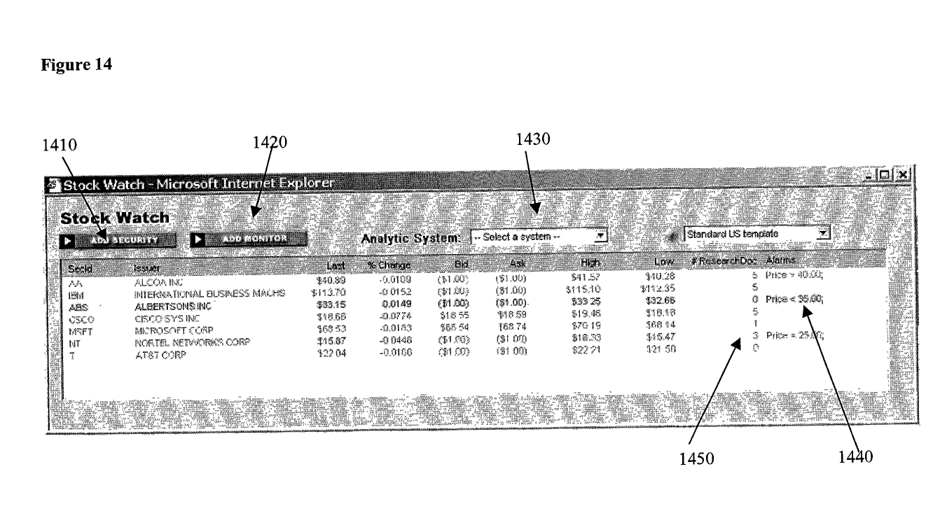

FIG. 14 is a depiction of an embodiment of a method for integrating investment management tools illustrating a stock watch interface. In situations where the manager wishes to monitor specific stocks, the integrated system can provide a real-time summary of individually chosen securities. The manager can add or delete securities 1410 as he or she feels fit and adjust the monitor criteria used by the integrated investment tools 1420. The monitoring criteria for each stock is displayed in the main widow 1440 indicating what must happen to the price of the security before an alert will be triggered.

The stock watch interface also allows a user to select a particular security and launch any of the investment tools 1430 with the selected security's data being populated into the chosen analytical tool. As described herein, the display can be customized to aid the manager in achieving his goals for portfolio management. In the depicted embodiment the user has elected to integrate results from a data research investment tool indicated how many research reports are available about each security 1450. As the system is fully integrated, each of these reports could be launched for further review from this interface. Just as the depiction provides data research results, other investment tool data can be presented for each security interest.

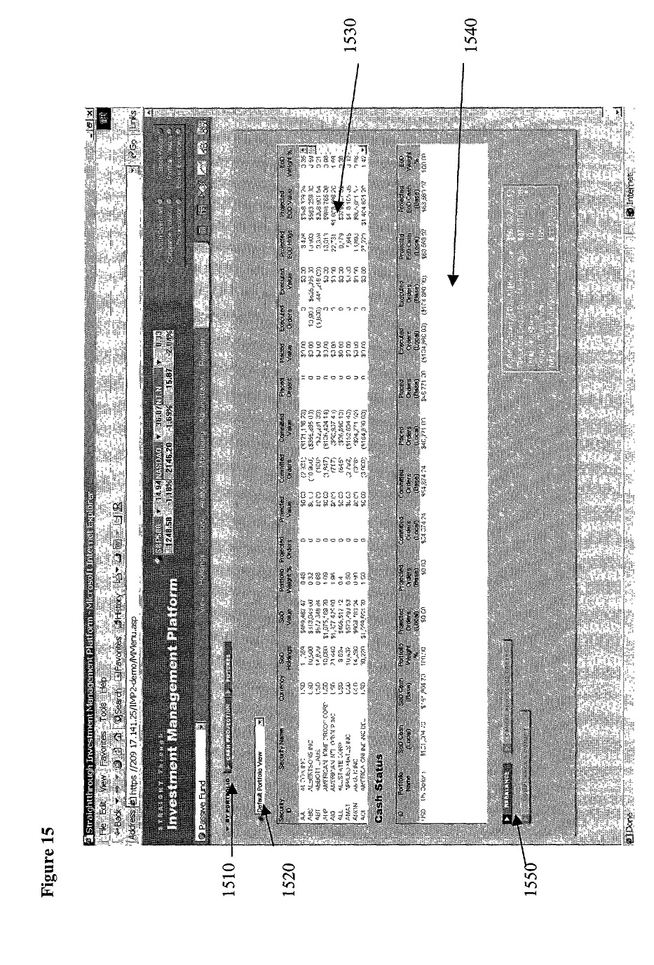

FIG. 15 is a depiction of an embodiment of a method for integrating investment management tools illustrating a by portfolio view of a user interface. The portfolio view offers an integrated combination of portfolio modeling functions that are unavailable in individual investment tools 1510. Furthermore, this interface shows that a cash projection and futures functionality is available to the manager at a single location 1520. In this depiction the primary window 1530 contains accounting information regarding portfolio status obtained from various investment tools. The depiction also shows order information and projected end of day holdings obtained from the investment tools. Likewise, the cash status window 1540 displays the effect of outstanding orders on cash levels. Included in this depiction is a direct link to a re-balancing investment tool 1550 where the user can select any portfolio holdings and direct the specified information to populate re-balance function. With the investment tool populated with the desired information, the user can launch the investment tool.

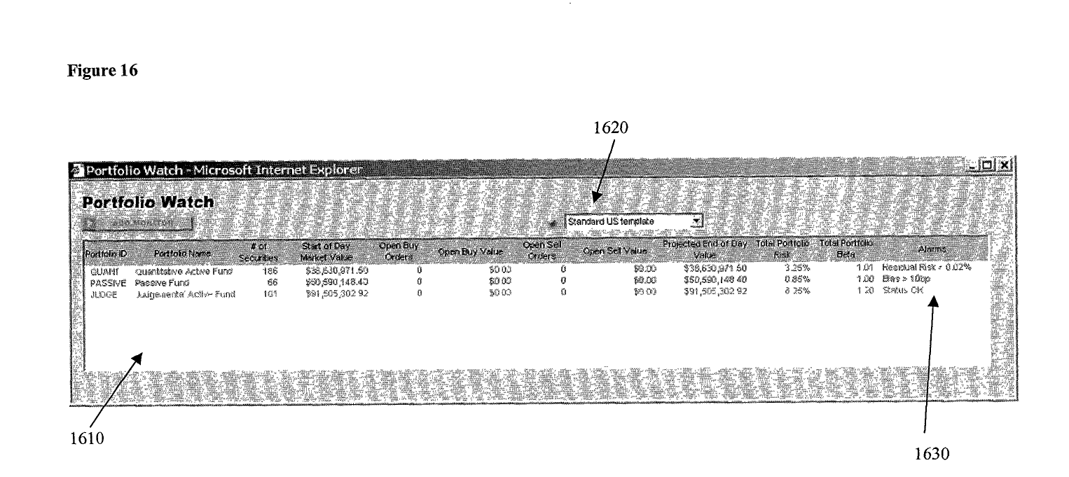

FIG. 16 depicts an embodiment of a method for integrating investment management tools illustrating a portfolio watch interface. As described herein, the view is customized by integrating several different aspects of each investment tool into a general display 1610. Once created, the user can select from the different templates 1620 depending on the manager's interest. Alerts or alarms can be fashioned for portfolios as well as individual stocks as illustrated by the residual risk alarm 1630.

A method and system for integrating investment management tools have been described with reference to particular embodiments and examples. Various modifications in approach and application are possible without departing from the spirit and scope of the invention, which is defined by the following claims.

What is claimed is:

1. A method for investment portfolio management, comprising:
accessing a plurality of investment tools that perform a plurality of functions;
communicating among the plurality of investment tools so as to make data from any of the plurality of investment tools available to the remaining plurality of investment tools;
performing real-time electronic crossing transactions; and
monitoring real-time at least one of the plurality of functions of at least one of the plurality of investment tools, wherein an intermediate value of at least one of the plurality of functions is available for review during a pending transaction.

2. The method of claim 1, further comprising reporting, including presenting at least one report that comprises data from at least one of the plurality of investment tools in a uniform format.

3. The method of claim 2, wherein the uniform format is predefined by a user.

4. The method of claim 1, wherein reporting includes directing at least one of the plurality of investment tools to indicate a level of completion of an assigned task.

5. The method of claim 1, wherein data is available to the plurality of investment tools through a central interface common to the plurality of investment tools.

6. The method of claim 1, wherein performing electronic crossing transactions includes:
receiving inputs from a first user indicating a willingness to match offsetting orders with a second user; and
placing the indication of willingness to match orders on a network.

7. The method of claim 1, wherein the plurality of investment tools further comprises portfolio analytic tools, portfolio accounting tools, risk management tools, research data tools, trade order management tools, and performance measurement and attribution tools.

8. The method of claim 1, wherein monitoring includes directing at least one of the plurality of investment tools to perform at least one of the plurality of functions at predefined intervals.

9. The method of claim 1, wherein the plurality of functions includes portfolio optimization.

10. The method of claim 1, wherein the plurality of functions includes re-balancing a portfolio.

11. The method of claim 1, wherein the plurality of functions includes risk assessment.

12. The method of claim 1, wherein the plurality of functions includes trade order execution.

13. The method of claim 1, wherein the plurality of functions includes measuring portfolio performance against a defined benchmark.

14. The method of claim 1, wherein the plurality of functions includes attributing portfolio performance to specific causes.

15. The method of claim 1, wherein the plurality of functions includes lending securities.

16. A method for investment portfolio management, comprising:
accessing a plurality of investment tools that perform a plurality of functions; communicating among the plurality of investment tools so as to make data from any of the plurality of investment tools available to the remaining plurality of investment tools, wherein data is available to the plurality of investment tools through a central interface common to the plurality of investment tools;
monitoring an investment process involving at least one of the plurality of investment tools, wherein monitoring includes making an intermediate value available during a transaction.

17. The method of claim 16, further comprising:
receiving inputs from a first user indicating a willingness to match offsetting orders with a second user on a real-time basis; and
placing the indication of willingness to match orders on a network.

18. The method of claim 16, wherein the indication of willingness to offset orders is placed on a electronic crossing network.

19. A method for managing investments comprising:
establishing a central interface common to a plurality of investment tools that perform a plurality of f unctions, wherein the plurality of investment tools communicate so as to make data from at least one of the plurality of investment tools available to the remaining investment tools;
reporting data from at least one of the plurality of investment tools to a user in a uniform format defined by the user including the level of completion of an assigned task of at least one of the functions of at least one of the investment tools;
performing electronic crossing transactions, wherein the user indicates a willingness match offsetting orders; and
monitoring at least one of the plurality of functions involving at least one of the plurality of investment tools, wherein an intermediate value of at least one of the plurality of functions is available for review by the user during a pending transaction.

20. The method of claim 19, wherein monitoring includes directing at least one of the plurality of investment tools to perform at least one of the plurality of fimctions at predefined intervals.

21. The method of claim 19, wherein reporting includes directing at least one of the plurality of investment tools to indicate a level of completion of an assigned task.

22. The method of claim 19, wherein the plurality of investment tools include portfolio analytic tools, portfolio accounting tools, risk management tools, research data tools, trade order management tools, and performance measurement and attribution tools.

23. A system for managing investment portfolios, comprising:
at least one user interface;
at least one processor;
at least one display device coupled to the processor;
at least one memory device coupled among the at least one processor, the at least one user interface, and the at least one display device, wherein the at least one memory device stores instructions that when executed, cause the processor to:
establish a central interface common to the plurality of investment tools, that perform the plurality of functions wherein the plurality of investment tools communicate so as to make data from at least one of the plurality of investment tools available to the remaining investment tools;
report data from at least one of the plurality of investment tools to a user in a uniform format defined by the user including a level of completion of an assigned task of at least one of the functions of at least one of the investment tools;
perform electronic crossing transactions, wherein the user indicates a willingness to trade at least one first security for at least one second security;
monitor at least one of the plurality of functions involving at least one of the plurality of investment tools, wherein an intermediate value of at least one of the plurality of functions is available for review by the user during a pending transaction.

24. A system for investment portfolio management, comprising:
at least one client browser, wherein the at least one client browser includes at least one processor capable of executing instructions;
at least one server;
at least one memory device coupled among the at least one client browser and the at least one server in a computer network, wherein the memory device stores instructions that when executed, causes the processor to;
establish a central interface common to the plurality of investment tools, that perform the plurality of functions wherein the plurality of investment tools communicate so as to make data from at least one of the plurality of investment tools available to the remaining investment tools;
report data from at least one of the plurality of investment tools to a user in a uniform format defined by the user, including the level of completion of an assigned task of at least one of the functions of at least one of the investment tools.

25. The system of claim 24, further comprising instructions that cause the system to indicate a first user's willingness to match offsetting orders with a second user.

26. The system of claim 24, further comprising instructions that cause the system to monitor at least one of the plurality of functions of at least one of the plurality of investment tools, wherein an intermediate value of at least on e of the plurality of functions is available for review by the user during a pending transaction.

27. A computer-readable medium, comprising executable instructions for investment portfolio management which, when executed in a processing system, causes the system to:
establish a central interface common to a plurality of investment tools, wherein the plurality investment tools that perform a plurality of functions communicate so as to make data from at least one of the plurality of investment tools available to the remaining investment tools;
report data from at least one of the plurality of investment tools to a first user in a uniform format defined by the first user including the level of completion of an assigned task of at least one of the functions of at least one of the investment tools;
indicate the first user's willingness to offset an order with a second user; and
monitor at least one of the plurality of functions involving at least one of the plurality of investment tools, wherein an intermediate value of at least one of the plurality of functions is available for review by the user during a pending transaction.

28. An electromagnetic medium, comprising executable instructions for investment portfolio management which, when executed in a processing system, causes the system to:
establish a central interface common to a plurality of investment tools, wherein the plurality investment tools that perform a plurality of functions communicate so as to make data from at least one of the plurality of investment tools available to the remaining investment tools;
report data from at least one of the plurality of investment tools to a first user in a uniform format defined by the first user including the level of completion of an assigned task of at least one of the functions of at least one of the investment tools;
indicate the first user's willingness to offset an order with a second user; and
monitor at least one of the plurality of functions involving at least one of the plurality of investment tools, wherein an intermediate value of at least one of the plurality of functions is available for review by the user during a pending transaction.
